(19) United States
(12) Patent Application Publication
(10) Pub. No.: US 2025/0076560 A1
(43) Pub. Date: Mar. 6, 2025

(54) LIGHT SOURCE MODULE

(71) Applicant: CHAMP VISION DISPLAY INC., MIAO-LI COUNTY (TW)

(72) Inventors: Chin-Ku Liu, Miao-Li County (TW); Chung-Hao Wu, Miao-Li County (TW); Hsin-Hung Lee, Miao-Li County (TW); Chun-Chien Liao, Miao-Li County (TW)

(73) Assignee: CHAMP VISION DISPLAY INC., MIAO-LI COUNTY (TW)

(21) Appl. No.: 18/820,173

(22) Filed: Aug. 29, 2024

(30) Foreign Application Priority Data
Aug. 31, 2023 (CN) 202311111239.1

(51) Int. Cl. F21V 8/00

(52) U.S. Cl. CPC G02B 6/0036; G02B 6/006; G02B 6/0068; G02B 6/0078

(57) ABSTRACT

A light source module includes a light guide plate, a first light source, multiple first optical microstructures, and multiple second optical microstructures. The first light source is disposed on a side of a first light incident surface of the light guide plate. The first and second optical microstructures are disposed on a bottom surface of the light guide plate, and respectively located in a first and a second zone. A first light receiving surface of each first optical microstructure facing the first light source has a first edge connecting the bottom surface, and a perpendicular bisector of the first edge passes through the first light source. The first zone does not overlap the second zone. A second light receiving surface of each second optical microstructure has a second edge connecting the bottom surface, and a perpendicular bisector of the second edge does not pass through the first light source.

### CROSS-REFERENCE TO RELATED APPLICATION

This application claims the priority benefit of China application serial no. 202311111239.1, filed on Aug. 31, 2023. The entirety of the above-mentioned patent application is hereby incorporated by reference herein and made a part of this specification.

### BACKGROUND

### Technical Field

The disclosure relates to a light source module, and in particular, to a light source module with a display function.

### Related Art

With the advancement of lighting technology, in addition to lighting devices that are generally used to provide lighting functions, decorative lighting panels (light source module) that provide decorative effects have also been developed on the market. In this kind of decorative lighting panel, optical microstructures are formed on the bottom surface of the light guide plate, and the position of each optical microstructure and the angle of its reflective surface are configured according to the effect that the decorative lighting panel needs to present. After being incident from the side surface (light incident surface) of the light guide plate, the light emitted by the light source may be transmitted toward the light emitting surface of the light guide plate through reflection by the optical microstructure and emits light, allowing the user to see patterns or text formed by the light on the side of the light emitting surface of the light guide plate.

In recent years, in order to improve the visual experience of viewers, the demand for using decorative lighting panels to present more vivid images has gradually increased. In order to increase the dynamic effect of the image, the number of light sources may be increased or addressable or programmable light sources may be selected. However, these methods not only increase production costs, but also the driver circuit boards used in general decorative lighting panel products cannot be directly applied to such decorative lighting panel products with dynamic effects.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

An embodiment of the disclosure provides a light source module. The light source module includes a light guide plate, a first light source, a plurality of first optical microstructures, and a plurality of second optical microstructures. The light guide plate has a first light incident surface and a bottom surface connected to the first light incident surface. The first light source is disposed on one side of the first light incident surface of the light guide plate. The first optical microstructures are disposed on the bottom surface of the light guide plate and located in a first zone of the bottom surface. Each of the first optical microstructures has a first light receiving surface disposed toward the first light source. Each of the first light receiving surfaces has a first edge connecting the bottom surface, and a perpendicular bisector of the first edge passes through the first light source. The second optical microstructures are disposed on the bottom surface of the light guide plate and located in a second zone of the bottom surface. The first zone does not overlap the second zone. Each of the second optical microstructures has a second light receiving surface. Each of the second light receiving surfaces has a second edge connecting the bottom surface, and a perpendicular bisector of the second edge does not pass through the first light source.

To make the above features and advantages of the disclosure clearer and easier to understand, embodiments will be specifically provided below and described in detain with reference to the accompanying drawings.

Other objectives, features and advantages of the disclosure will be further understood from the further technological features disclosed by the embodiments of the disclosure wherein there are shown and described preferred embodiments of this disclosure, simply by way of illustration of modes best suited to carry out the disclosure.

### BRIEF DESCRIPTION OF THE DRAWINGS

FIG. 1 is a schematic front view of a light source module according to a first embodiment of the disclosure.

FIG. 2A is a schematic side view of the light source module of FIG. 1.

FIG. 2B is a schematic cross-sectional view of the light source module of FIG. 1.

FIG. 3 is a schematic diagram of the distribution of normalized brightness versus viewing angle after light is reflected by the optical microstructures in different zones of FIG. 1.

FIGS. 4A to 4C are schematic diagrams of images presented by the light source module of FIG. 1 in three viewing angle directions parallel to the light incident surface of the light guide plate.

FIG. 5 is a schematic front view of a light source module according to a second embodiment of the disclosure.

FIG. 6A is a schematic side view of the light source module of FIG. 5.

FIG. 6B is a schematic cross-sectional view of the light source module of FIG. 5.

FIG. 7A to 7C are schematic diagrams of images presented by the light source module of FIG. 5 in three viewing angle directions parallel to a plane perpendicular to the light incident surface and the light emitting surface of the light guide plate.

FIG. 8 is a schematic front view of a light source module according to a third embodiment of the disclosure.

FIG. 9A is a schematic side view of the light source module of FIG. 8.

FIG. 9B is a schematic cross-sectional view of the light source module of FIG. 8.

FIG. 10 is a schematic front view of a light source module according to a fourth embodiment of the disclosure.

FIG. 11 is a schematic front view of a light source module according to a fifth embodiment of the disclosure.

FIG. 12 is a schematic front view of a light source module according to a sixth embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. The components of the disclosure may be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Thus, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

The disclosure provides a light source module, which has better dynamic effect of presenting images and has cost advantages.

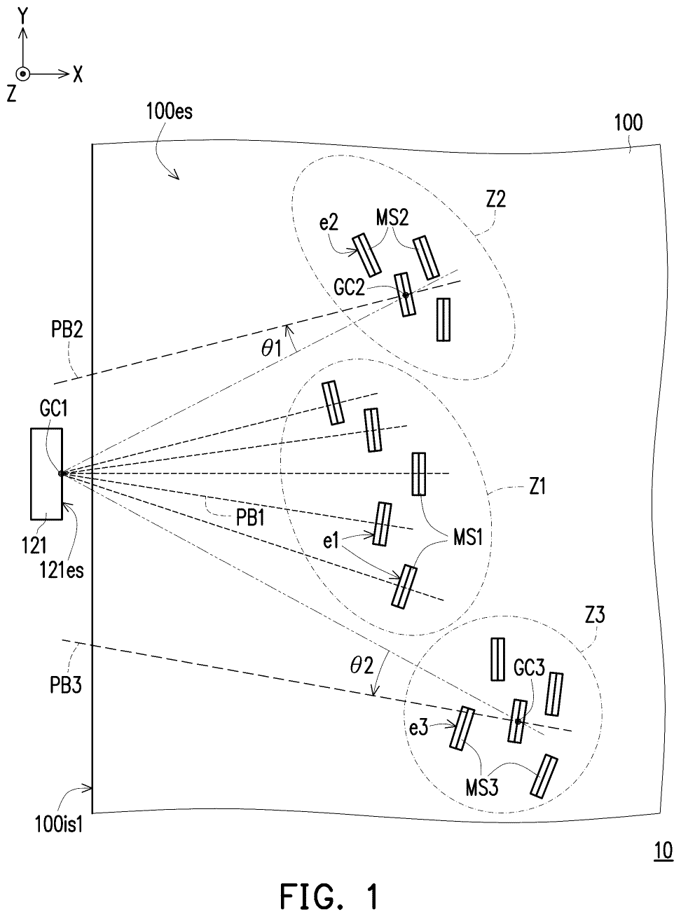

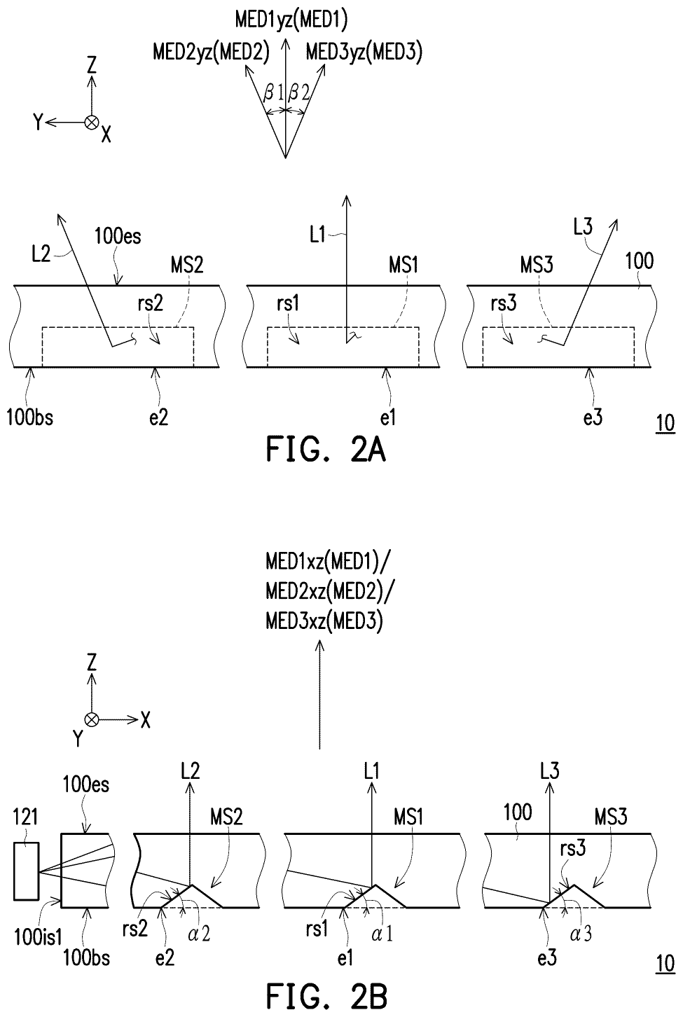

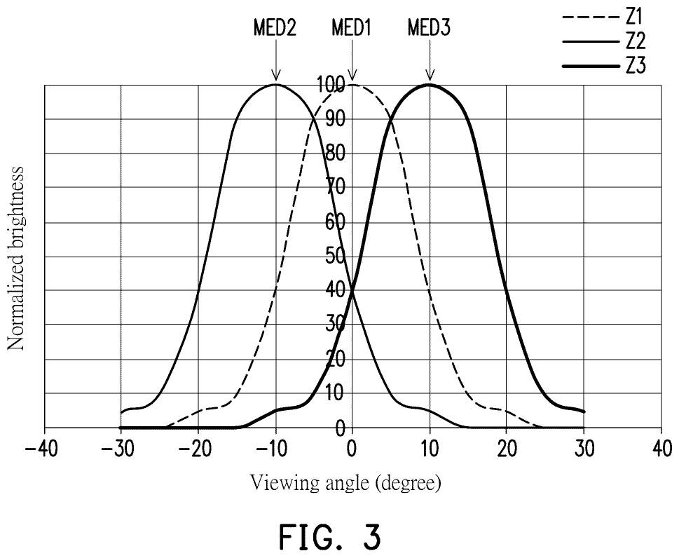

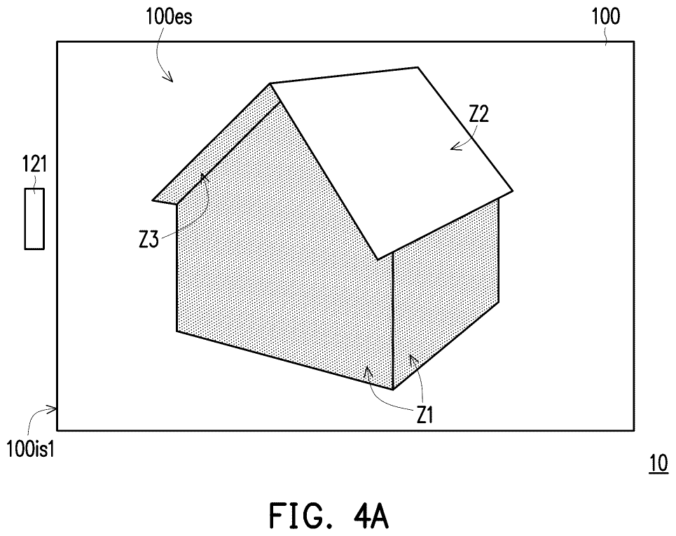

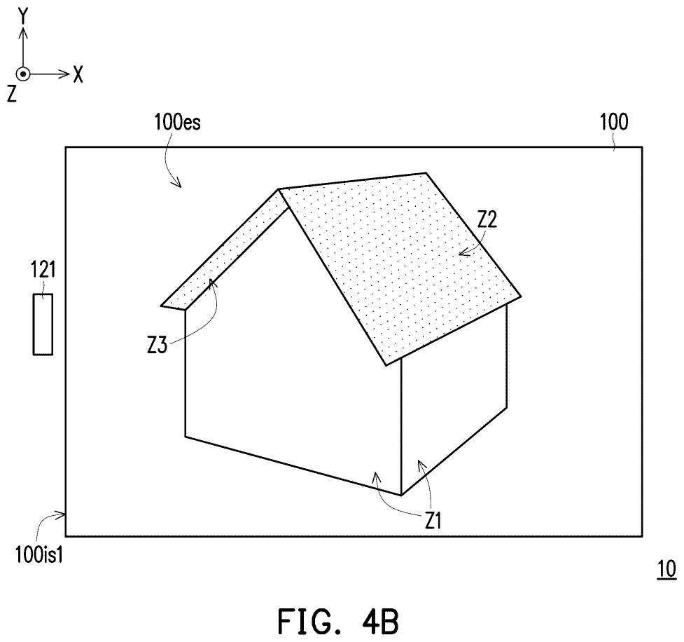

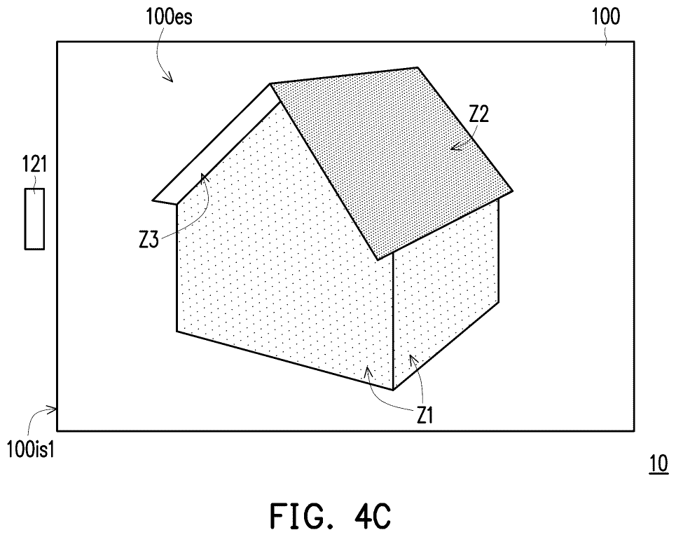

FIG. 1 is a schematic front view of a light source module according to the first embodiment of the disclosure. FIG. 2A is a schematic side view of the light source module of FIG. 1. FIG. 2B is a schematic cross-sectional view of the light source module of FIG. 1. FIG. 3 is a schematic diagram of the distribution of normalized brightness versus viewing angle after light is reflected by the optical microstructures in different zones of FIG. 1. FIGS. 4A to 4C are schematic diagrams of images presented by the light source module of FIG. 1 in three viewing angle directions parallel to the light incident surface of the light guide plate.

Please refer to FIG. 1, FIG. 2A, and FIG. 2B. A light source module 10 includes a light guide plate 100, a first light source 121, and a plurality of optical microstructures. The light guide plate 100 has a first light incident surface 100is1, a light emitting surface 100es, and a bottom surface 100bs. The light emitting surface 100es and the bottom surface 100bs are opposite to each other, and both are connected to the first light incident surface 100is1. The first light source 121 is disposed on one side of the first light incident surface 100is1 of the light guide plate 100, the first light source 121 is, for example, a light-emitting diode or light-emitting element. The optical microstructures are disposed on the bottom surface 100bs of the light guide plate 100.

For example, in this embodiment, the bottom surface 100bs of the light guide plate 100 may have a first zone Z1, a second zone Z2, and a third zone Z3. A plurality of optical microstructures MS1 are provided in the first zone Z1. A plurality of optical microstructures MS2 are provided in the second zone Z2. A plurality of optical microstructures MS3 are provided in the third zone Z3.

It is particularly noted that these zones of the bottom surface 100bs do not overlap along the normal direction of the light emitting surface 100es (for example, the axial direction of the Z axis). In other words, each of these zones is continuously distributed on the bottom surface 100bs. From another point of view, one single (or a few) optical microstructure MS1, optical microstructure MS2, and optical microstructure MS3 are not alternately arranged.

In this embodiment, the plurality of optical microstructures MS1 located in the first zone Z1 respectively has a light receiving surface rs1 facing the first light source 121. Each of the light receiving surfaces rs1 has an edge e1 connecting the bottom surface 100bs. The plurality of optical microstructures MS2 located in the second zone Z2 respectively has a light receiving surface rs2. Each of the light receiving surfaces rs2 has an edge e2 connecting the bottom surface 100bs. The plurality of optical microstructures MS3 located in the third zone Z3 respectively has a light receiving surface rs3. Each of the light receiving surfaces rs3 has an edge e3 connecting the bottom surface 100bs. Specifically, in this embodiment, each of the optical microstructures is, for example, a concave triangular prism-shaped structure.

It is particularly noted that a perpendicular bisector PB1 of the edge e1 passes through the first light source 121 (for example, an orthographic projection of the perpendicular bisector PB1 on a virtual extended surface of the bottom surface 100bs passes through an orthographic projection area of the first light source 121 on a virtual extended surface of the bottom surface 100bs, as shown in FIG. 1. In the disclosure, similar contents are as described above and will not be repeated), but a perpendicular bisector PB2 of the edge e2 and a perpendicular bisector PB3 of the edge e3 do not pass through the first light source 121. More specifically, in this embodiment, the perpendicular bisectors PB2 of the plurality of optical microstructures MS2 pass through the same side of the first light source 121 (for example, the upper side of the first light source 121 in FIG. 1, but not limited thereto), and the perpendicular bisectors PB3 of the plurality of optical microstructures MS3 pass through the same other side of the first light source 121 (for example, the lower side of the first light source 121 in FIG. 1, but not limited thereto).

For example, in this embodiment, the perpendicular bisector PB1 of the edge e1 of the light receiving surface rs1 of each optical microstructure MS1 passes through an emitting surface 121es of the first light source 121, for example, substantially through a geometric center GC1 of the emitting surface 121es (for example, the perpendicular bisector PB1 has an intersection point with the emitting surface 121es, and the offset between the intersection point and the geometric center GC1 is not larger than 5% of the width of the emitting surface 121es in the Y direction). In other words, the edge e1 of each optical microstructure MS1 is not necessarily parallel. On the other hand, there is a virtual connection line between a geometric center GC2 of the optical microstructure MS2 (for example, the geometric center of the orthographic projection area of the optical microstructure MS2 on the bottom surface 100bs) and the geometric center GC1 of the first light source 121. The perpendicular bisector PB2 of the edge e2 of the light receiving surface rs2 of each optical microstructure MS2 deflects clockwise by an angle θ1 relative to the virtual connection line, and the angle θ1 deflected varies with the relative positions of the optical microstructure MS2 and the first light source 121. There is also a virtual connection line between a geometric center GC3 of the optical microstructure MS3 and the geometric center GC1 of the first light source 121. The perpendicular bisector PB3 of the edge e3 of the light receiving surface rs3 of each optical microstructure MS3 deflects counter-clockwise by an angle θ2 relative to the virtual connection line, and the angle θ2 deflected varies with the relative positions of the optical microstructure MS3 and the first light source 121. The clockwise deflection or counter-clockwise deflection mentioned here is, for example, the rotation of the optical microstructure along an axis (not shown) that passes through its geometric center and is parallel to the Z axis. In one embodiment, as shown in FIG. 1, the intersection point of the perpendicular bisector PB2 of each optical microstructure MS2 and an extended plane (not shown) of the emitting surface 121es of the first light source 121 is located on one side of the first light source 121, and its distance from the geometric center GC1 of the first light source 121 is, for example, within the range of two to ten times (or two to five times) the width of the emitting surface 121es of the first light source 121 in the Y direction. The intersection point of the perpendicular bisector PB3 of each optical microstructure MS3 and the extended plane of the emitting surface 121es of the first light source 121 is located on the other side of the first light source 121, and its distance from the geometric center GC1 of the first light source 121 is, for example, within the range of two to ten times (or two to five times) the width of the emitting surface 121es of the first light source 121 in the Y direction.

On the other hand, there is a base angle α1 between the light receiving surface rs1 of the optical microstructure MS1 and the virtual extended surface of the bottom surface 100bs (shown in FIG. 2B). There is a base angle α2 between the light receiving surface rs2 of the optical microstructure MS2 and the virtual extended surface of the bottom surface 100bs. There is a base angle α3 between the light receiving surface rs3 of the optical microstructure MS3 and the virtual extended surface of the bottom surface 100bs. In this embodiment, the base angle α1 of the optical microstructure MS1, the base angle α2 of the optical microstructure MS2, and the base angle α3 of the optical microstructure MS3 are, for example, the same.

In this embodiment, the first light source 121 emits a first light L1, a second light L2, and a third light L3 toward the optical microstructures MS1, the optical microstructures MS2, and the optical microstructures MS3 respectively. The first light L1 has a first main light emitting direction MED1 after being reflected by the optical microstructures MS1. The second light L2 has a second main light emitting direction MED2 after being reflected by the optical microstructures MS2. The third light L3 has a third main light emitting direction MED3 after being reflected by the optical microstructures MS3.

It is particularly noted that the first main light emitting direction MED1 of the first light L1 reflected by the optical microstructure MS1, the second main light emitting direction MED2 of the second light L2 reflected by the optical microstructure MS2, and the third main light emitting directions MED3 of the third light L3 reflected by the optical microstructure MS3 are different from each other, as shown in FIG. 2A.

Further, in this embodiment, the first main light emitting direction MED1 may be parallel to the Z axis (i.e., perpendicular to the X axis and the Y axis), where the X axis, the Y axis, and the Z axis are perpendicular to each other. That is, the first main light emitting direction MED1 is perpendicular to the light emitting surface 100es of the light guide plate 100 (i.e., an XY plane formed by the X axis and the Y axis).

However, neither the second main light emitting direction MED2 nor the third main light emitting direction MED3 is parallel to the Z axis. More specifically, an orthographic projection MED2yz of the second main light emitting direction MED2 on a YZ plane (that is, the plane formed by the Y axis and the Z axis) has an axial component in the same direction as the Y axis (as shown in FIG. 2A), and an orthographic projection MED3yz of the third main light emitting direction MED3 on the YZ plane has an axial component in the opposite direction to the Y axis (as shown in FIG. 2A).

From another point of view, there is an angle β1 between the orthographic projection MED2yz of the second main light emitting direction MED2 on the YZ plane and an orthographic projection MED1yz of the first main light emitting direction MED1 on the YZ plane, and there is an angle β2 between the orthographic projection MED3yz of the third main light emitting direction MED3 on the YZ plane and the orthographic projection MED1yz of the first main light emitting direction MED1 on the YZ plane. In this embodiment, the orthographic projection MED2yz and the orthographic projection MED3yz of the second main light emitting direction MED2 and the third main light emitting direction MED3 on the YZ plane may be respectively located on opposite sides of the orthographic projection MED1yz of the first main light emitting direction MED1 on the YZ plane, and the angle β1 and the angle β2 may selectively be the same, but are not limited thereto.

In particular, since the base angle α1 of the optical microstructure MS1, the base angle α2 of the optical microstructure MS2, and the base angle α3 of the optical microstructure MS3 of this embodiment are all the same, the first main light emitting direction MED1, the second main light emitting direction MED2, and the third main light emitting direction MED3 are all parallel to the first light incident surface 100is1 or the YZ plane of the light guide plate 100. That is, an orthographic projection MED1xz, an orthographic projection MED2xz, and an orthographic projection MED3xz of the first main light emitting direction MED1, the second main light emitting direction MED2, and the third main light emitting direction MED3 respectively on an XZ plane (i.e. the plane formed by the X axis and the Z axis) do not have axial components in the same direction as or opposite direction to the X axis.

That is, in this embodiment, the first main light emitting direction MED1, the second main light emitting direction MED2, and the third main light emitting direction MED3 are not parallel to each other in the dimension of the YZ plane (as shown in FIG. 2A), but are parallel to each other in the dimension of the XZ plane (as shown in FIG. 2B).

In the dimension of the YZ plane, the distribution curves of the normalized brightness to viewing angle of each of the first light L1 reflected by the optical microstructure MS1 of the first zone Z1, the second light L2 reflected by the optical microstructure MS2 of the second zone Z2, and the third light L3 reflected by the optical microstructure MS3 of the third zone Z3 are shown in FIG. 3. As may be seen from FIG. 3, in this embodiment, the first main light emitting direction MED1 of the first light L1 is, for example, the direction of the viewing angle of 0 degrees; the second main light emitting direction MED2 of the second light L2 is, for example, the direction of the viewing angle of −10 degrees; and the third main light emitting direction MED3 of the third light L3 is, for example, the direction of the viewing angle of +10 degrees.

It is particularly noted that in the first main light emitting direction MED1 (for example, viewed from the direction of a viewing angle of 0 degrees), the light emitting brightness of the first zone Z1 is significantly higher than the light emitting brightness of the second zone Z2 and the light emitting brightness of the third zone Z3, and the light emitting brightness of the second zone Z2 is equivalent to the light emitting brightness of the third zone Z3. In the second main light emitting direction MED2, the light emitting brightness of the second zone Z2 is significantly higher than the light emitting brightness of the first zone Z1 and the light emitting brightness of the third zone Z3, and the light emitting brightness of the first zone Z1 is higher than the light emitting brightness of the third zone Z3. In the third main light emitting direction MED3, the light emitting brightness of the third zone Z3 is significantly higher than the light emitting brightness of the first zone Z1 and the light emitting brightness of the second zone Z2, and the light emitting brightness of the first zone Z1 is higher than the light emitting brightness of the second zone Z2. In this way, when the user views the light guide plate 100 in different directions, the user may see different brightness changes in different zones.

Please refer to FIG. 4A to FIG. 4C. In this embodiment, the light guide plate 100 is, for example, a decorative lighting panel, and the orthographic projections of the first zone Z1, the second zone Z2 and the third zone Z3 provided with different optical microstructures on the light emitting surface 100es may form a decorative pattern, for example, the pattern shown in FIG. 4A is a house pattern (the content of the pattern is not particularly limited in the disclosure). The first zone Z1, the second zone Z2, and the third zone Z3 are different zones (such as walls or roofs) that constitute the house pattern. In particular, the first zone Z1, the second zone Z2, and the third zone Z3 described in the disclosure are not general decorative patterns that produce a flashing effect, thus, the size of each zone is relatively large. For example, the length of the first zone Z1 (the second zone Z2) is at least one tenth or more of the length of the light guide plate 100, and the width of the first zone Z1 (the second zone Z2) is at least one tenth or more of the width of the light guide plate 100. As shown in FIG. 4A, when the user views the light guide plate 100 at a viewing angle of −10 degrees in the dimension of the YZ plane (for example, the upper viewing angle along the YZ plane in FIG. 4B), the brightness of the second zone Z2 is higher than the light emitting brightness of each of the first zone Z and the third zone Z3, and the light emitting brightness of the first zone Z1 is higher than the light emitting brightness of the third zone Z3.

As shown in FIG. 4B, when the user views the light guide plate 100 at a viewing angle of 0 degrees in the dimension of the YZ plane (for example, the front viewing angle along the YZ plane in FIG. 4B), the brightness of the first zone Z1 is higher than the light emitting brightness of each of the second zone Z2 and the third zone Z3, and the light emitting brightness of the second zone Z2 is equivalent to the light emitting brightness of the third zone Z3.

As shown in FIG. 4C, when the user views the light guide plate 100 at a viewing angle of +10 degrees in the dimension of the YZ plane (for example, the lower viewing angle along the YZ plane in FIG. 4B), the brightness of the third zone Z3 is higher than the light emitting brightness of each of the second zone Z2 and the first zone Z1, and the light emitting brightness of the first zone Z1 is higher than the light emitting brightness of the second zone Z2.

That is to say, when the user views the decorative pattern formed by the first zone Z1, the second zone Z2, and the third zone Z3 at different viewing angles in the dimension of the YZ plane, the brightness distribution of the decorative patterns varies with the change of viewing angle, which in turn produces a dynamic effect with light and shadow changes. In this way, the flat pattern can produce a three-dimensional visual effect when the user moves to view the light guide plate 100. On the other hand, the light source module 10 of this embodiment achieves the dynamic effect of light emitting distribution by arranging optical microstructures in different ways in different zones of the light guide plate 100, thus compared with the current method of increasing the number of light sources or selecting addressable light sources, the light source module 10 also have lower production costs.

Other embodiments will be enumerated below to describe the disclosure in detail, in which the same components will be given with the same symbols, and descriptions of the same technical content will be omitted. Please refer to the previous embodiments for the omitted parts, which will not be described again below.

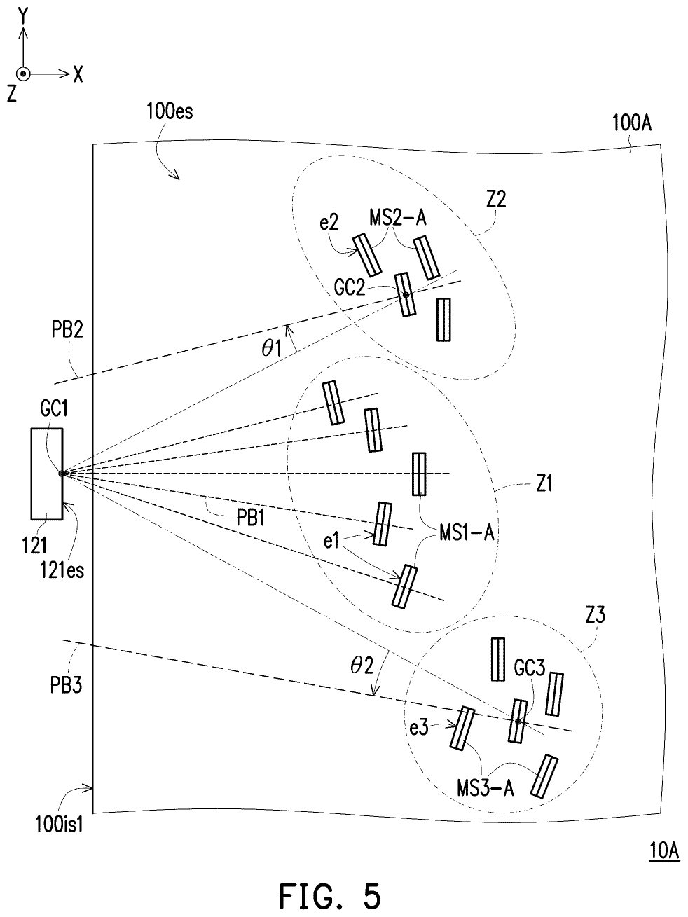

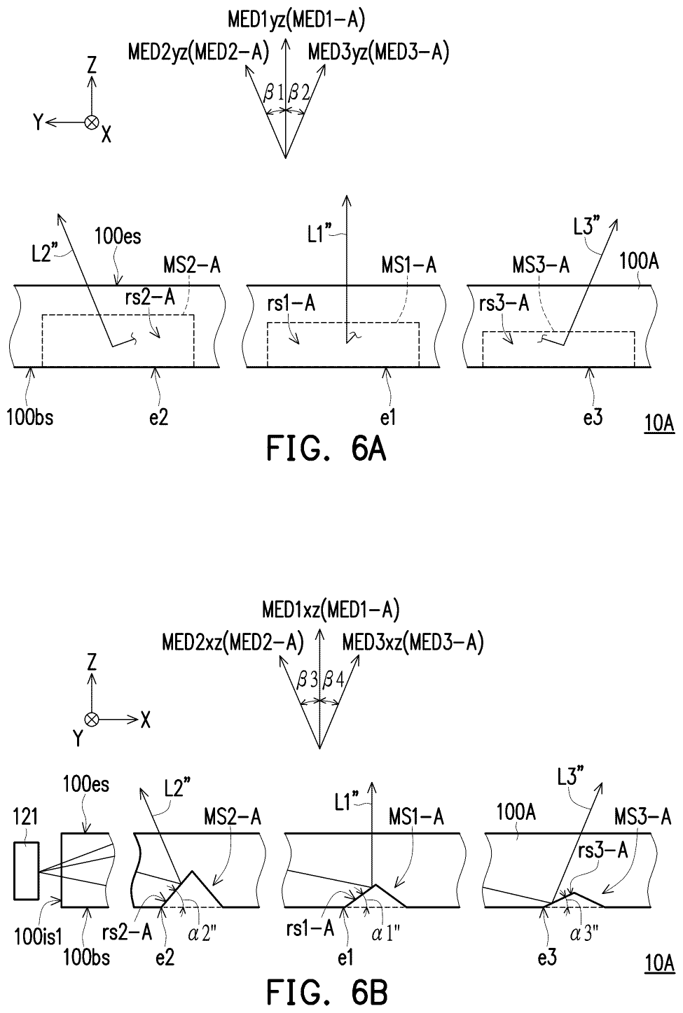

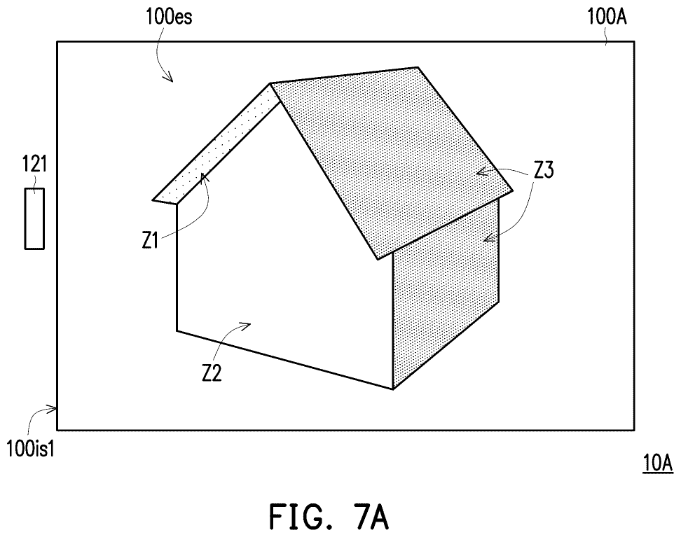

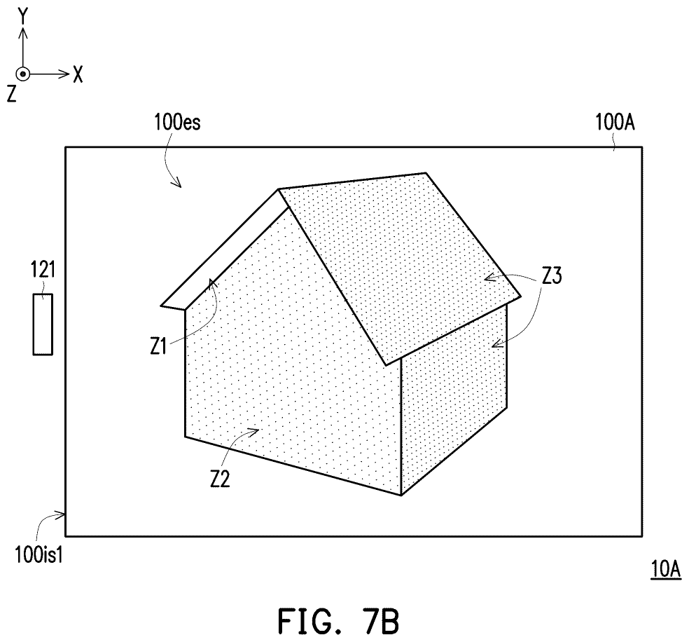

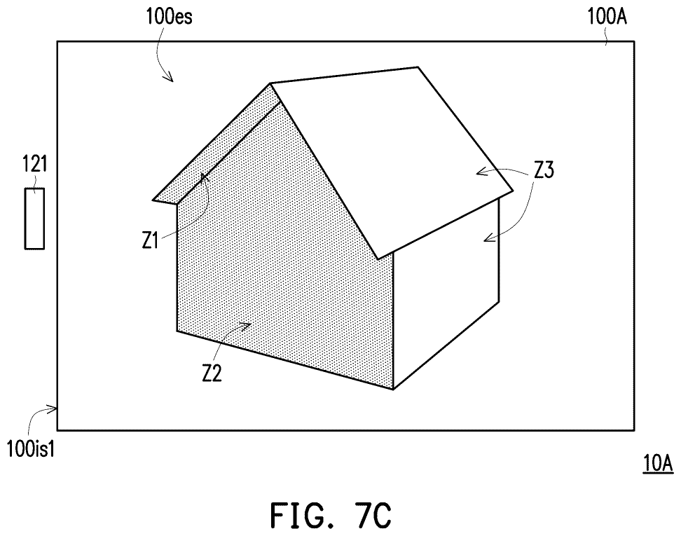

FIG. 5 is a schematic front view of a light source module according to a second embodiment of the disclosure. FIG. 6A is a schematic side view of the light source module of FIG. 5. FIG. 6B is a schematic cross-sectional view of the light source module of FIG. 5. FIG. 7A to 7C are schematic diagrams of images presented by the light source module of FIG. 5 in three viewing angle directions parallel to a plane perpendicular to the light incident surface and the light emitting surface of the light guide plate.

Please refer to FIG. 5, FIG. 6A, and FIG. 6B. Different from the light guide plate 100 of FIG. 1 and FIG. 2, in a light source module 10A of this embodiment, a base angle α1″ of a light receiving surface rs1-A of an optical microstructure MS1-A of a light guide plate 100A may be selectively larger than a base angle α3″ of a light receiving surface rs3-A of an optical microstructure MS3-A, and may be selectively smaller than a base angle α2″ of a light receiving surface rs2-A of an optical microstructure MS2-A. In other embodiments, the relationship of angle sizes between the base angle α1″, the base angle α2″, and the base angle α3″ may also be adjusted according to the actual situation.

That is, the base angles of the optical microstructure MS1-A, the optical microstructure MS2-A, and the optical microstructure MS3-A of this embodiment are all different. Thus, a first light L1″, a second light L2″, and a third light L3″ respectively reflected through these optical microstructures are not parallel to each other in the dimension of the XZ plane, as shown in FIG. 6B.

For example, in this embodiment, the orthographic projection MED1xz of a first main light emitting direction MED1-A of the first light L1″ on the XZ plane is parallel to the Z axis, and the orthographic projection MED2xz of a second main light emitting direction MED2-A of the second light L2″ on the XZ plane and the orthographic projection MED3xz of a third main light emitting direction MED3-A of the third light L3″ on the XZ plane are not parallel to the Z axis. More specifically, the orthographic projection MED2xz of the second main light emitting direction MED2-A on the XZ plane has an axial component in the opposite direction to the X axis (as shown in FIG. 6B), and the orthographic projection MED3xz of the third main light emitting direction MED3-A on the XZ plane has an axial component in the same direction as the X axis (as shown in FIG. 6B).

From another point of view, there is an angle β3 between the orthographic projection MED2xz of the second main light emitting direction MED2-A on the XZ plane and the orthographic projection MED1xz of the first main light emitting direction MED1-A on the XZ plane, and there is an angle β4 between the orthographic projection MED3xz of the third main light emitting direction MED3-A on the XZ plane and the orthographic projection MED1xz of the first main light emitting direction MED1-A on the XZ plane. In this embodiment, the orthographic projection MED2xz and the orthographic projection MED3xz of the second main light emitting direction MED2-A and the third main light emitting direction MED3-A on the XZ plane may be respectively located on the opposite sides of the orthographic projection MED1xz of the first main light emitting direction MED1-A on the XZ plane, and the angle β3 and the angle β4 may selectively be the same, but are not limited thereto.

Since the configuration relationship between the optical microstructure MS1-A, the optical microstructure MS2-A, and the optical microstructure MS3-A and the first light source 121 of this embodiment is similar, respectively, to the configuration relationship between the optical microstructure MS1, the optical microstructure MS2, and the optical microstructure MS3 and the first light source 121 in FIG. 1, detailed descriptions may be referred to in relevant paragraphs of the foregoing embodiments, and will not be described again here.

Based on the foregoing configuration, in the light source module 10A of this embodiment, the first main light emitting direction MED1-A, the second main light emitting direction MED2-A, and the third main light emitting direction MED3-A are not parallel to each other in the dimension of the YZ plane, nor are they parallel to each other in the dimension of the XZ plane. Specifically, as shown in the schematic view of FIG. 5, the first main light emitting direction MED1-A emits in the forward direction, the second main light emitting direction MED2-A emits in the upper left direction, and the third main light emitting direction MED3-A emits in the lower right direction.

In particular, in this embodiment, the base angle α1″ of each optical microstructure MS1-A is the same, the base angle α2″ of each optical microstructure MS2-A is the same, and the base angle α3″ of each optical microstructure MS3-A is the same, but the disclosure is not limited thereto. In another embodiment, the angle of the base angle α1″ of each optical microstructure MS1-A may be varied gradually, the angle of the base angle α2″ of each optical microstructure MS2-A may be varied gradually, and the angle of the base angle α3″ of each optical microstructure MS3-A may be varied gradually. In this way, the brightness in each zone may also have slight changes in the dimension of the XZ plane. In yet another embodiment, for example, the light guide plate only has multiple optical microstructures MS1-A, and the multiple optical microstructures MS1-A may be divided into different microstructure groups, the angle of base angle α1″ of the optical microstructure MS1-A of each microstructure group is the same, but the angle of the base angle α1″ of the optical microstructure MS1-A of different microstructure groups is different. In this way, the brightness of the light emitting zone corresponding to each microstructure group may be different in the dimension of the XZ plane.

In this embodiment, when the user views the light guide plate 100A at the left viewing angle in FIG. 7A in the dimension of the XZ plane, the brightness of the second zone Z2 is higher than the light emitting brightness of each of the first zone Z1 and the third zone Z3, and the light emitting brightness of the first zone Z1 is higher than the light emitting brightness of the third zone Z3.

When the user views the light guide plate 100A at the front viewing angle in FIG. 7B in the dimension of the XZ plane, the brightness of the first zone Z1 is higher than the light emitting brightness of each of the second zone Z2 and the third zone Z3, and the light emitting brightness of the second zone Z2 is equivalent to the light emitting brightness of the third zone Z3.

When the user views the light guide plate 100A at the right viewing angle in FIG. 7C in the dimension of the XZ plane, the brightness of the third zone Z3 is be higher than the light emitting brightness of each of the second zone Z2 and the first zone Z1, and the light emitting brightness of the first zone of Z1 is higher than the light emitting brightness of the second zone Z2.

Since the brightness distribution change of the light guide plate 100A of this embodiment when viewed at different viewing angles in the dimension of the YZ plane are similar to that of the light guide plate 100 in FIGS. 4A to 4C, detailed descriptions may be referred to in relevant paragraphs of the foregoing embodiments, and will not be described again here.

In this embodiment, when the user views the decorative pattern formed by the first zone Z1, the second zone Z2, and the third zone Z3 at different viewing angles in the dimension of the YZ plane, the brightness distribution of the decorative patterns varies with the change of viewing angle, which in turn produces a dynamic effect with light and shadow changes. On the other hand, the light source module 10A of this embodiment achieves the dynamic effect of light emitting distribution by arranging optical microstructures in different ways in different zones of the light guide plate 100A, thus compared with the current method of increasing the number of light sources or selecting addressable light sources, the light source module 10A also have lower production costs.

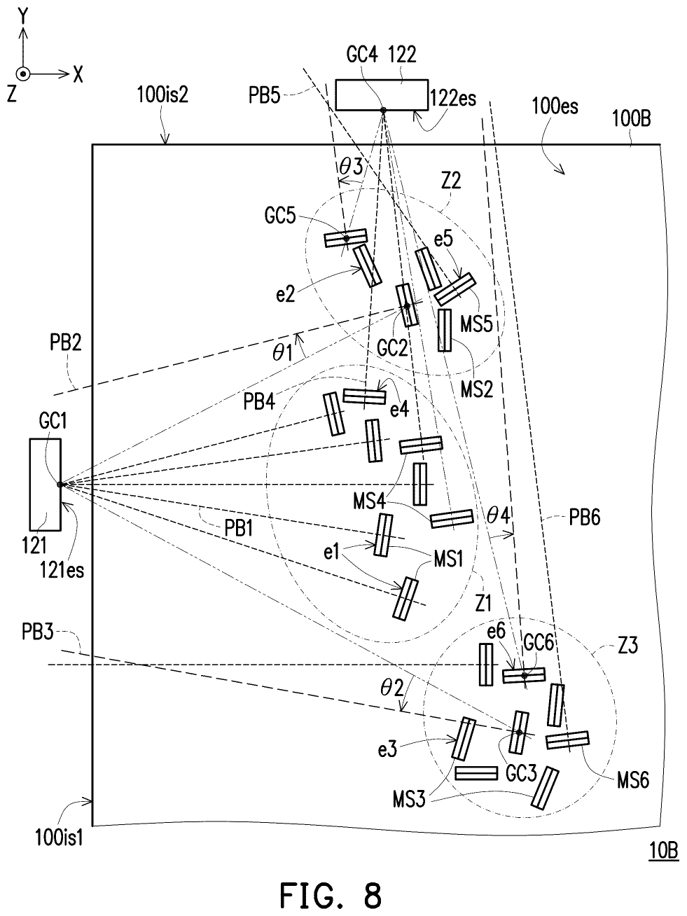

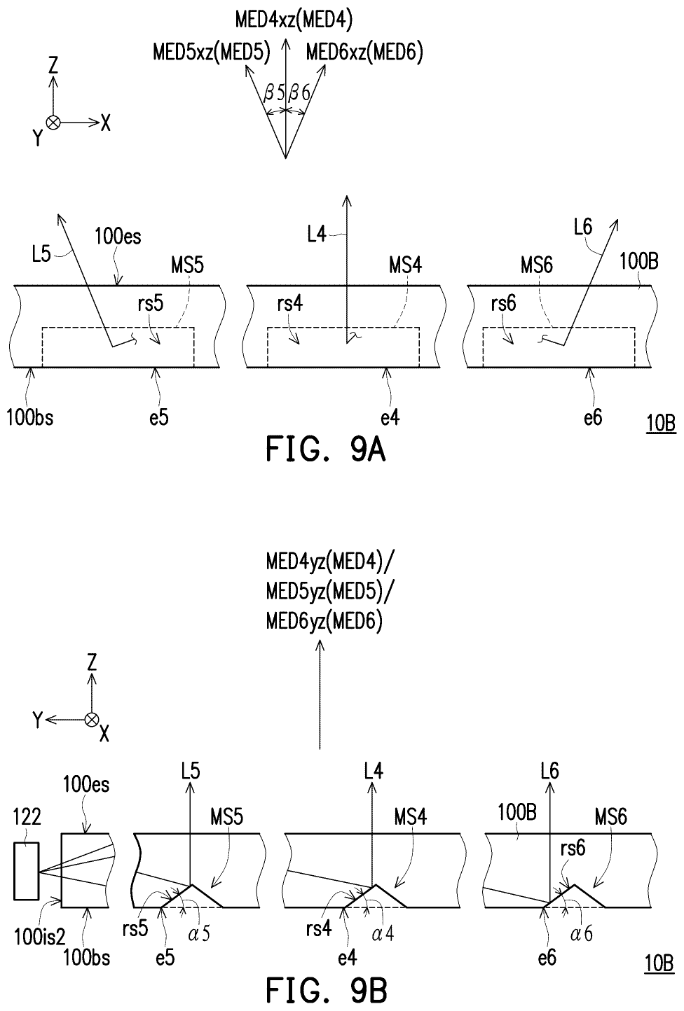

FIG. 8 is a schematic front view of a light source module according to a third embodiment of the disclosure. FIG. 9A is a schematic side view of the light source module of FIG. 8. FIG. 9B is a schematic cross-sectional view of the light source module of FIG. 8. Please refer to FIG. 8, FIG. 9A, and FIG. 9B. The difference between a light source module 10B of this embodiment and the light source module 10 of FIG. 1 is that the number of light sources and the number of optical microstructures are different.

Specifically, in this embodiment, the light source module 10B further includes a second light source 122, a plurality of optical microstructures MS4, a plurality of optical microstructures MS5, and a plurality of optical microstructures MS6. The second light source 122 is disposed on one side of a second light incident surface 100is2 of a light guide plate 100B. The second light incident surface 100is2 is connected to the bottom surface 100bs and the first light incident surface 100is1. The plurality of optical microstructures MS4 (i.e. the third optical microstructures) are provided on the bottom surface 100bs of the light guide plate 100B and are located in the first zone Z1. The plurality of optical microstructures MS5 (i.e. the fourth optical microstructures) are provided on the bottom surface 100bs of the light guide plate 100B and are located in the second zone Z2. The plurality of optical microstructures MS6 are disposed on the bottom surface 100bs of the light guide plate 100B and located in the third zone Z3.

In this embodiment, the plurality of optical microstructures MS4 located in the first zone Z1 respectively has a light receiving surface rs4 facing the second light source 122. Each of the light receiving surfaces rs4 has an edge e4 connecting the bottom surface 100bs. The plurality of optical microstructures MS5 located in the second zone Z2 respectively has a light receiving surface rs5. Each of the light receiving surfaces rs5 has an edge e5 connecting the bottom surface 100bs. The plurality of optical microstructures MS6 located in the third zone Z3 respectively has a light receiving surface rs6. Each of the light receiving surfaces rs6 has an edge e6 connecting the bottom surface 100bs.

It is particularly noted that a perpendicular bisector PB4 of the edge e4 passes through the second light source 122 (for example, an orthographic projection of the perpendicular bisector PB4 on a virtual extended surface of the bottom surface 100bs passes through an orthographic projection area of the second light source 122 on a virtual extended surface of the bottom surface 100bs), but a perpendicular bisector PB5 of the edge e5 and a perpendicular bisector PB6 of the edge e6 do not pass through the second light source 122. More specifically, in this embodiment, the perpendicular bisectors PB5 of the plurality of optical microstructures MS5 pass through the same side of the second light source 122 (for example, the left side of the second light source 122 in FIG. 8, but not limited thereto), and the perpendicular bisectors PB6 of the plurality of optical microstructures MS6 pass through the same other side of the second light source 122 (for example, the right side of the second light source 122 in FIG. 8, but not limited thereto).

For example, in this embodiment, the perpendicular bisector PB4 of the edge e4 of the light receiving surface rs4 of each optical microstructure MS4 passes through an emitting surface 122es of the second light source 122, for example, through a geometric center GC4 of the emitting surface 122es (i.e., the perpendicular bisectors of the edges e4 of the light receiving surfaces rs4 pass through a same side of the second light source 122). In other words, the edges e4 of the optical microstructures MS4 are not necessarily parallel to each other. On the other hand, there is a virtual connection line between a geometric center GC5 of the optical microstructure MS5 (for example, the geometric center of the orthographic projection area of the optical microstructure MS5 on the bottom surface 100bs) and the geometric center GC4 of the second light source 122. The perpendicular bisector PB5 of the edge e5 of the light receiving surface rs5 of each optical microstructure MS5 deflects clockwise by an angle θ3 relative to the virtual connection line, and the angle θ3 deflected varies with the relative positions of the optical microstructure MS5 and the second light source 122. There is also a virtual connection line between a geometric center GC6 of the optical microstructure MS6 and the geometric center GC4 of the second light source 122. The perpendicular bisector PB6 of the edge e6 of the light receiving surface rs6 of each optical microstructure MS6 deflects counter-clockwise by an angle θ4 relative to the virtual connection line, and the angle θ4 deflected varies with the relative positions of the optical microstructure MS6 and the second light source 122. The clockwise deflection or counter-clockwise deflection mentioned here is, for example, the rotation of the optical microstructure along an axis (not shown) that passes through its geometric center and is parallel to the Z axis.

On the other hand, there is a base angle α4 between the light receiving surface rs4 of the optical microstructure MS4 and the virtual extended surface of the bottom surface 100bs. There is a base angle α5 between the light receiving surface rs5 of the optical microstructure MS5 and the virtual extended surface of the bottom surface 100bs. There is a base angle α6 between the light receiving surface rs6 of the optical microstructure MS6 and the virtual extended surface of the bottom surface 100bs. In this embodiment, the base angle α4 of the optical microstructure MS4, the base angle α5 of the optical microstructure MS5, and the base angle α6 of the optical microstructure MS6 are, for example, the same.

In this embodiment, the second light source 122 emits a fourth light L4, a fifth light L5, and a sixth light L6 toward the optical microstructures MS4, the optical microstructures MS5, and the optical microstructures MS6 respectively. The fourth light L4 has a fourth main light emitting direction MED4 after being reflected by the optical microstructures MS4. The fifth light L5 has a fifth main light emitting direction MED5 after being reflected by the optical microstructures MS5. The sixth light L6 has a sixth main light emitting direction MED6 after being reflected by the optical microstructures MS6.

It is particularly noted that the fourth main light emitting direction MED4 of the fourth light L4 reflected by the optical microstructure MS4, the fifth main light emitting direction MED5 of the fifth light L5 reflected by the optical microstructure MS5, and the sixth main light emitting direction MED6 of the sixth light L6 reflected by the optical microstructure MS6 are different from each other.

Further, in this embodiment, the fourth main light emitting direction MED4 may be parallel to the Z axis. That is, the first main light emitting direction MED1 is perpendicular to the light emitting surface 100es of the light guide plate 100 (i.e., the XY plane). However, neither the fifth main light emitting direction MED5 nor the sixth main light emitting direction MED6 is parallel to the Z axis. More specifically, an orthographic projection MED5xz of the fifth main light emitting direction MED5 on the XZ plane has an axial component in the opposite direction to the X axis, and an orthographic projection MED6xz of the sixth main light emitting direction MED6 on the XZ plane has an axial component in the same direction as the X axis.

From another point of view, there is an angle 5 between the orthographic projection MED5xz of the fifth main light emitting direction MED5 on the XZ plane and an orthographic projection MED4xz of the fourth main light emitting direction MED4 on the XZ plane, and there is an angle β6 between the orthographic projection MED6xz of the sixth main light emitting direction MED6 on the XZ plane and the orthographic projection MED4xz of the fourth main light emitting direction MED4 on the XZ plane. In this embodiment, the orthographic projection MED5xz and the orthographic projection MED6xz of the fifth main light emitting direction MED5 and the sixth main light emitting direction MED6 on the XZ plane may be respectively located on opposite sides of the orthographic projection MED4xz of the fourth main light emitting direction MED4 on the XZ plane, and the angle β5 and the angle β6 may selectively be the same, but are not limited thereto.

In particular, since the base angle α4 of the optical microstructure MS4, the base angle α5 of the optical microstructure MS5 and the base angle α6 of the optical microstructure MS6 of this embodiment are all the same, the fourth main light emitting direction MED4, the fifth main light emitting direction MED5, and the sixth main light emitting direction MED6 are all parallel to the second light incident surface 100is2 or the XZ plane of the light guide plate 100B. That is, an orthographic projection MED4yz, an orthographic projection MED5yz, and an orthographic projection MED6yz of the fourth main light emitting direction MED4, the fifth main light emitting direction MED5, and the sixth main light emitting direction MED6 respectively on the YZ plane do not have axial components that are in the same direction as or in the opposite direction to the Y axis.

That is, in this embodiment, the fourth main light emitting direction MED4, the fifth main light emitting direction MED5, and the sixth main light emitting direction MED6 are not parallel to each other in the dimension of the XZ plane (as shown in FIG. 9A), but are parallel to each other in the dimension of the YZ plane (as shown in FIG. 9B).

Since the configuration relationship between the optical microstructure MS1, the optical microstructure MS2 and the optical microstructure MS3 and the first light source 121 of this embodiment is similar, respectively, to the configuration relationship of the optical microstructure MS1, the optical microstructure MS2, and the optical microstructure MS3 and the first light source 121 in FIG. 1, detailed descriptions may be referred to in relevant paragraphs of the foregoing embodiments, and will not be described again here.

In particular, the light source module 10A in FIGS. 5 to FIG. 6B achieves the dynamic effect of its light emitting distribution in the dimension of the XZ plane by using different base angles of the optical microstructures (as shown in FIGS. 7A to 7C). However, in this embodiment, the light source module 10B achieves the dynamic effect of its light emitting distribution in the dimension of the XZ plane by adding a second set of light sources and optical microstructures.

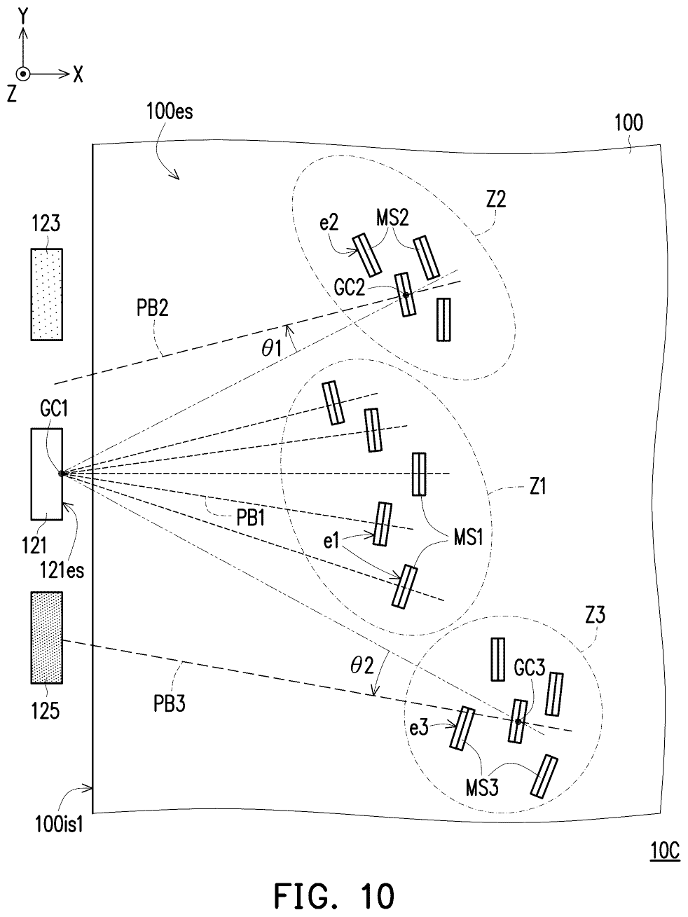

FIG. 10 is a schematic front view of a light source module according to a fourth embodiment of the disclosure. Please refer to FIG. 10. The difference between a light source module 10C of this embodiment and the light source module 10 of FIG. 1 is that the number of light sources are different. For example, in this embodiment, the light source module 10C further includes an auxiliary light source 123 and an auxiliary light source 125, which are disposed on one side of the first light incident surface 100is1 of the light guide plate 100 and respectively located on opposite sides of the first light source 121. The auxiliary light source 125, the first light source 121, and the auxiliary light source 123 are arranged in sequence along the Y direction, for example (the Y direction is, for example, parallel to the first light incident surface 100is1 and parallel to the light emitting surface 100es). The distance between the center of the emitting surface of the auxiliary light source 123 and the center of the emitting surface 121es of the first light source 121 is, for example, within the range of two to ten times the width of the emitting surface 121es of the first light source 121 in the Y direction. The distance between the center of the emitting surface of the other auxiliary light source 125 and the center of the emitting surface 121es of the first light source 121 is, for example, within the range of two to ten times the width of the emitting surface 121es of the first light source 121 in the Y direction.

It is particularly noted that the auxiliary light source 123, the auxiliary light source 125, and the first light source 121 respectively have different light emitting brightness. For example, in this embodiment, the light emitting brightness of the auxiliary light source 123 may be smaller than the light emitting brightness of the first light source 121 and larger than the light emitting brightness of the auxiliary light source 125, but is not limited thereto. Accordingly, the dynamic effect with light and shadow changes between different zones on the light guide plate 100 can be further improved. Preferably, the percentage value of the respective light emitting brightness of the auxiliary light source 123 and the auxiliary light source 125 to the light emitting brightness of the first light source 121 may be less than 60%.

However, the disclosure is not limited thereto. The light color of at least one of the auxiliary light source 123 and the auxiliary light source 125 may also be different from the light color of the first light source 121. Accordingly, the dynamic effect with the colors of different zones on the light guide plate 100 changing with the viewing angle can also be increased. Similarly, in the light source module 10B of FIG. 8, the light colors of the first light source 121 and the second light source 122 may also be selectively different to further increase the dynamic effect with the colors of different zones on the light guide plate 100B changing with the viewing angle.

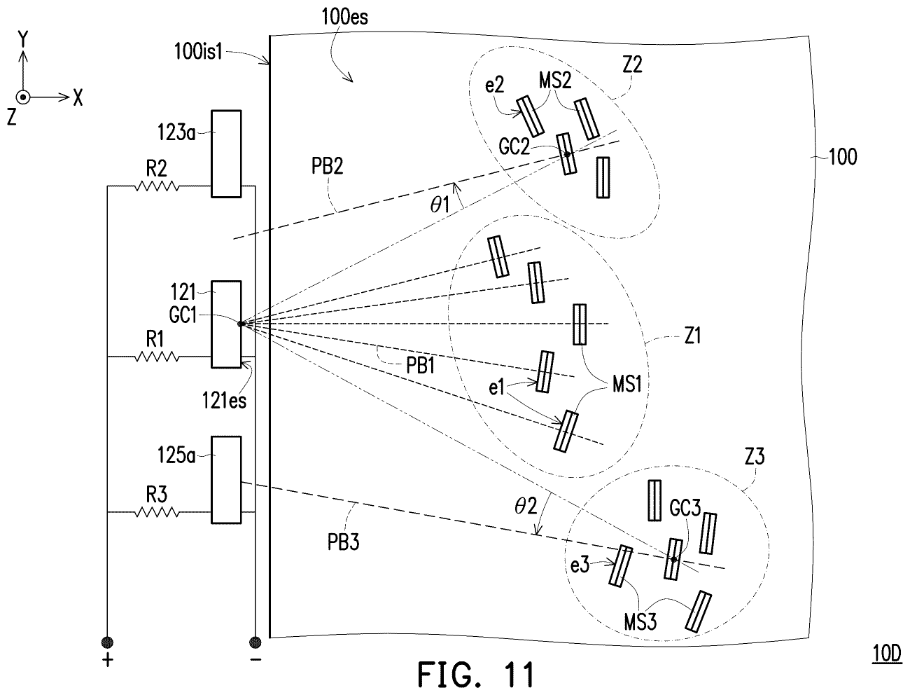

FIG. 11 is a schematic front view of a light source module according to the fifth embodiment of the disclosure. Please refer to FIG. 11. The difference between a light source module 10D of this embodiment and the light source module 10C of FIG. 10 is that the driving circuits for the first light source 121 and the auxiliary light source are different. Specifically, in this embodiment, the first light source 121, an auxiliary light source 123a, and an auxiliary light source 125a are connected in parallel, the first light source 121, the auxiliary light source 123a, and the auxiliary light source 125a are respectively connected in series with a first resistor R1, a second resistor R2, and a third resistor R3, and the resistance values of these resistors are different from each other.

By connecting multiple resistors with different resistance values in series with light sources, the flexibility of selecting the first light source 121, the auxiliary light source 123a, and the auxiliary light source 125a can be increased. For example, multiple light-emitting elements with the same maximum light emitting brightness may be used, and then the light emitting brightness of each of these light-emitting elements may be controlled by connecting resistors with different resistance values in series. Accordingly, the dynamic effect with light and shadow changes between different zones on the light guide plate 100 can be further improved.

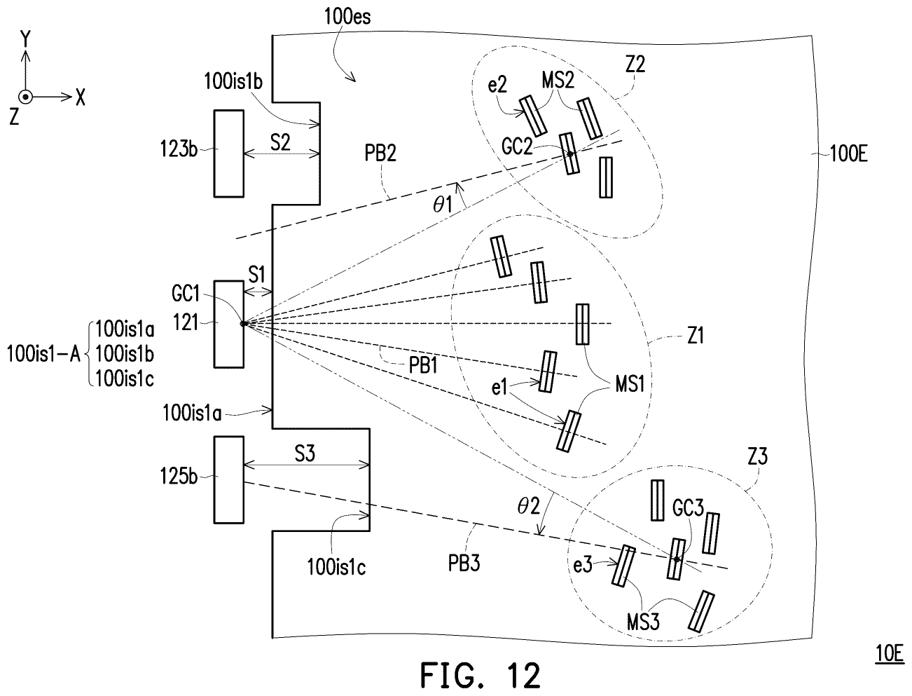

FIG. 12 is a schematic front view of a light source module according to a sixth embodiment of the disclosure. Please refer to FIG. 12. The difference between a light source module 10E of this embodiment and the light source module 10C of FIG. 10 is that the configuration of the light guide plate is different. For example, in this embodiment, a first light incident surface 100is1-A of a light guide plate 100E of the light source module 10E has a first sub-surface 100is1a, a second sub-surface 100is1b, and a third sub-surface 100is1c. The first light source 121 is disposed corresponding to the first sub-surface 100is1a. An auxiliary light source 123b is disposed corresponding to the second sub-surface 100is1b. An auxiliary light source 125b is disposed corresponding to the third sub-surface 100is1c.

There is a first spacing S1 between the first light source 121 and the first sub-surface 100is1a along the direction X, there is a second spacing S2 between the auxiliary light source 123b and the second sub-surface 100is1b along the direction X, and there is a third spacing S3 between the auxiliary light source 125b and the third sub-surface 100is1c along the direction X. It is particularly noted that in this embodiment, the second spacing S2 is larger than the first spacing S1 and smaller than the third spacing S3. That is, the first spacing S1, the second spacing S2, and the third spacing S3 are different from each other. For example, the second spacing S2 is two times to four times the first spacing S1, and the third spacing S3 is three times to six times the first spacing S1.

Since the optical coupling efficiency between the light source and the light guide plate decreases as the distance between the light source and the light guide plate increases, the brightness of the light emitted by the auxiliary light source 123b and coupled to the light guide plate 100E is smaller than the brightness of the light emitted by the first light source 121 and coupled to the light guide plate 100E, but is larger than the brightness of the light emitted by the auxiliary light source 125b and coupled to the light guide plate 100E. Accordingly, the dynamic effect with light and shadow changes between different zones on the light guide plate 100E can be further improved.

To sum up, in the light source module according to an embodiment of the disclosure, on the bottom surface of the light guide plate, a plurality of first optical microstructures are provided in the first zone, and a plurality of second optical microstructures are provided in the second zone. The perpendicular bisector of the first edge of the first light receiving surface of the first optical microstructure passes through the first light source, but the perpendicular bisector of the second edge of the second light receiving surface of the second optical microstructure does not pass through the first light source. Through such a configuration, the main light emitting direction of the light emitted by the first light source after being reflected by the first optical microstructure is different from the main light emitting direction of the light emitted by the first light source after being reflected by the second optical microstructure. Thus, the relationship between the light emitting brightness of the first zone and the second zone may vary with different viewing angles, thereby showing a dynamic effect of changing light emitting distribution.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Thus, the term “the disclosure”, “the disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the present disclosure is intended to be dedicated to the public regardless of whether the element or component is explicitly recited in the following claims.

What is claimed is:

1. A light source module, comprising:
a light guide plate, having a first light incident surface and a bottom surface connected to the first light incident surface;
a first light source, disposed on one side of the first light incident surface of the light guide plate;
a plurality of first optical microstructures, disposed on the bottom surface of the light guide plate and located in a first zone of the bottom surface, wherein each of the first optical microstructures has a first light receiving surface facing the first light source, the first light receiving surface of each of the first optical microstructures has a first edge connecting the bottom surface, and a perpendicular bisector of the first edge passes through the first light source; and
a plurality of second optical microstructures, disposed on the bottom surface of the light guide plate and located in a second zone of the bottom surface, wherein the first zone does not overlap the second zone, each of the second optical microstructures has a second light receiving surface, the second light receiving surface of each of the second optical microstructures has a second edge connecting the bottom surface, and a perpendicular bisector of the second edge does not pass through the first light source.

2. The light source module according to claim 1, wherein the first light source emits a first light toward each of the first optical microstructures, a plurality of the first lights have a first main light emitting direction after being reflected by the first optical microstructures respectively, the first light source further emits a second light toward each of the second optical microstructures, a plurality of the second lights have a second main light emitting direction after being reflected by the second optical microstructures respectively, and the first main light emitting direction is different from the second main light emitting direction.

3. The light source module according to claim 2, wherein the first main light emitting direction and the second main light emitting direction are parallel to the first light incident surface of the light guide plate.

4. The light source module according to claim 2, wherein the light guide plate further has a light emitting surface facing away from the bottom surface and connected to the first light incident surface, and the first main light emitting direction is perpendicular to the light emitting surface of the light guide plate.

5. The light source module according to claim 2, wherein the perpendicular bisectors of the second edges of the second light receiving surfaces pass through a same side of the first light source.

6. The light source module according to claim 2, wherein there is a first base angle between the first light receiving surface of each of the first optical microstructures and a virtual extended surface of the bottom surface, there is a second base angle between the second light receiving surface of each of the second optical microstructures and the virtual extended surface of the bottom surface, and the first base angle is different from the second base angle.

7. The light source module according to claim 1, further comprising:
an auxiliary light source, disposed on one side of the first light incident surface of the light guide plate, wherein the first light source and the auxiliary light source have different light emitting brightness.

8. The light source module according to claim 7, wherein the first light source and the auxiliary light source are connected in parallel, the first light source and the auxiliary light source are respectively connected in series with a first resistor and a second resistor, and a resistance value of the first resistor is different from a resistance value of the second resistor.

9. The light source module according to claim 1, further comprising:
an auxiliary light source, disposed on one side of the first light incident surface of the light guide plate, wherein the first light incident surface of the light guide plate has a first sub-surface and a second sub-surface, the first light source is disposed corresponding to the first sub-surface, the auxiliary light source is disposed corresponding to the second sub-surface, there is a first spacing between the first light source and the first sub-surface, there is a second spacing between the auxiliary light source and the second sub-surface, and the first spacing is different from the second spacing.

10. The light source module according to claim 1, further comprising:
an auxiliary light source, disposed on one side of the first light incident surface of the light guide plate, wherein the first light source and the auxiliary light source have different light colors.

11. The light source module according to claim 1, further comprising:
a second light source, disposed on one side of a second light incident surface of the light guide plate, wherein the second light incident surface is connected to the bottom surface and the first light incident surface; and
a plurality of third optical microstructures, disposed on the bottom surface of the light guide plate and located in the first zone of the bottom surface, wherein each of the third optical microstructures has a third light receiving surface facing the second light source, the third light receiving surface of each of the third optical microstructures has a third edge connecting the bottom surface, and a perpendicular bisector of the third edge passes through the second light source.

12. The light source module according to claim 11, further comprising:
a plurality of fourth optical microstructures, disposed on the bottom surface of the light guide plate and located in the second zone of the bottom surface, wherein each of the fourth optical microstructures has a fourth light receiving surface, the fourth light receiving surface of each of the fourth optical microstructures has a fourth edge connecting the bottom surface, and a perpendicular bisector of the fourth edge does not pass through the second light source.

13. The light source module according to claim 1, further comprising:
a second light source, disposed on one side of a second light incident surface of the light guide plate, wherein the second light incident surface is connected to the bottom surface and the first light incident surface;
a plurality of third optical microstructures, disposed on the bottom surface of the light guide plate and located in the first zone of the bottom surface, wherein each of the third optical microstructures has a third light receiving surface facing the second light source, and there is a first base angle between the third light receiving surface of each of the third optical microstructures and a virtual extended surface of the bottom surface; and
a plurality of fourth optical microstructures, disposed on the bottom surface of the light guide plate and located in the second zone of the bottom surface, wherein each of the fourth optical microstructures has a fourth light receiving surface facing the second light source, and there is a second base angle between the fourth light receiving surface of each of the fourth optical microstructures and the virtual extended surface of the bottom surface, wherein the first base angle is different from the second base angle.
